(19) United States
(12) Patent Application Publication
(10) Pub. No.: US 2023/0289863 A1
(43) Pub. Date: Sep. 14, 2023

(54) RECOMMENDATION SYSTEM

(71) Applicant: NTT DOCOMO, INC., Chiyoda-ku (JP)

(72) Inventors: Ryoki WAKAMOTO, Chiyoda-ku (JP); Shigeki TANAKA, Chiyoda-ku (JP); Yusuke FUKAZAWA, Chiyoda-ku (JP)

(73) Assignee: NTT DOCOMO, INC., Chiyoda-ku (JP)

(21) Appl. No.: 18/002,621

(22) PCT Filed: Jul. 6, 2021
(86) PCT No.: PCT/JP2021/025450

§ 371 Date: Dec. 20, 2022

(30) Foreign Application Priority Data
Jul. 7, 2020 (JP) 2020-117276

(51) Int. Cl. G06Q 30/0601

(52) U.S. Cl. CPC G06Q 30/0631; G06Q 50/12

(57) ABSTRACT

A recommendation system includes an acquisition unit configured to acquire order history information indicating an order history in the middle of a series of orders placed by a user, and a determination unit configured to predict a value related to a total amount of the series of orders placed by the user on the basis of the order history information acquired by the acquisition unit and determine an item to be recommended to the user on the basis of the order history information and the predicted value.

### TECHNICAL FIELD

The present invention relates to a recommendation system pertaining to item recommendation.

### BACKGROUND ART

Conventionally, it has been proposed to recommend a user’s next order on the basis of the user’s order history at restaurants (see, for example, Patent Literature 1).

### CITATION LIST

### Patent Literature

[Patent Literature 1] Japanese Unexamined Patent Publication No. 2019-91115

### SUMMARY OF INVENTION

### Technical Problem

In restaurants such as conveyor belt sushi restaurants, products offered to a user include various items such as desserts in addition to sushi, and the user sequentially orders these items. As disclosed in Patent Literature 1, simply using the user’s order history does not necessarily make it possible to appropriately recommend items at restaurants as described above. For example, desserts cannot be recommended at an appropriate timing.

An embodiment of the present invention was contrived in view of such circumstances, and an object thereof is to provide a recommendation system capable of recommending appropriate items at a restaurant such as a conveyor belt sushi restaurant.

### Solution to Problem

In order to achieve the above object, according to an embodiment of the present invention, there is provided a recommendation system including: an acquisition unit configured to acquire order history information indicating an order history in the middle of a series of orders placed by a user; and a determination unit configured to predict a value related to a total amount of the series of orders placed by the user on the basis of the order history information acquired by the acquisition unit and determine an item to be recommended to the user on the basis of the order history information and the predicted value.

In the recommendation system according to an embodiment of the present invention, for example, a value related to the total amount of a series of orders placed by a user, such as the remaining account amount or the total account amount, is predicted, and items to be recommended to the user are determined on the basis of the value. Therefore, according to the recommendation system of an embodiment of the present invention, it is possible to recommend appropriate items in consideration of the value related to the total amount of a series of orders placed by the user at a restaurant or the like such as a conveyor belt sushi restaurant.

### Advantageous Effects of Invention

According to an embodiment of the present invention, it is possible to recommend appropriate items at a restaurant or the like such as a conveyor belt sushi restaurant.

### BRIEF DESCRIPTION OF DRAWINGS

FIG. 1 is a diagram illustrating a configuration of a recommendation system according to an embodiment of the present invention.

FIG. 2 is a diagram illustrating information which is used by the recommendation system.

FIG. 3 is a diagram schematically illustrating a model which is used by the recommendation system.

FIG. 4 is a sequence diagram illustrating processing which is executed by the recommendation system according to the embodiment of the present invention.

FIG. 5 is a diagram illustrating a hardware configuration of the recommendation system according to the embodiment of the present invention.

### DESCRIPTION OF EMBODIMENTS

Hereinafter, an embodiment of a recommendation system according to the present invention will be described in detail with reference to the accompanying drawings. Meanwhile, in the description of the drawings, the same components are denoted by the same reference numerals and signs, and thus description thereof will not be repeated.

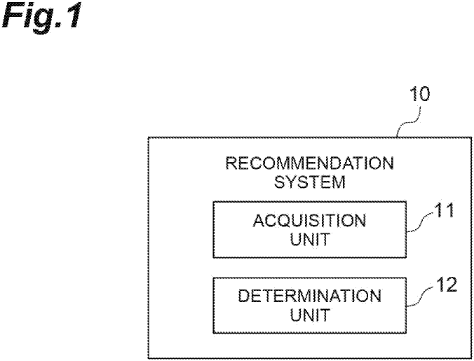

FIG. 1 shows a recommendation system 10 according to the present embodiment. The recommendation system 10 is a system (device) that recommends items to a user at a restaurant or the like. For example, the recommendation system 10 recommends the next item to order to a user on the basis of the user’s order history during a period from the time when the user (visitor) enters a store where items are provided to the time when the user leaves the store. Meanwhile, a store which is a target for recommendation is usually a store where a user orders items sequentially (as needed) without ordering all items at once (for example, a conveyor belt sushi restaurant or a pub). In the present embodiment, one session is assumed to be from the time when a user visits a store to the time when the user leaves the store. The recommendation system 10 recommends the next item to order to a user in one session on the basis of the user’s order history up to the middle of the one session. In the present embodiment, recommendation of items at a conveyor belt sushi restaurant will be described as an example.

In the present embodiment, users who are a target for recommendation may be a group consisting of a plurality of users who eat, drink, or the like at the same time. In the following description, even in the case of simply referring to a user, a group consisting of a plurality of users is also assumed to be included. For example, in the above store, each table is provided with an order panel which is used by a user. In that case, the user orders items by means of one order panel for each table. Therefore, even in the case of a group consisting of a plurality of users, it is necessary to recommend items not to an individual but to a group that shares an order panel.

The recommendation system 10 is constituted by a computer such as a server device. The recommendation system 10 may be constituted by a plurality of computers, that is, a computer system.

Next, the function of the recommendation system 10 according to the present embodiment will be described. As shown in FIG. 1, the recommendation system 10 is configured to include an acquisition unit 11 and a determination unit 12.

The acquisition unit 11 is a functional unit that acquires order history information indicating an order history in the middle of a series of orders placed by a user. The acquisition unit 11 may acquire location information relating to a location where an item is provided. The acquisition unit 11 may acquire time information relating to a time at which an item is provided. Each piece of information acquired by the acquisition unit 11 is information used to determine items to be recommended to the user.

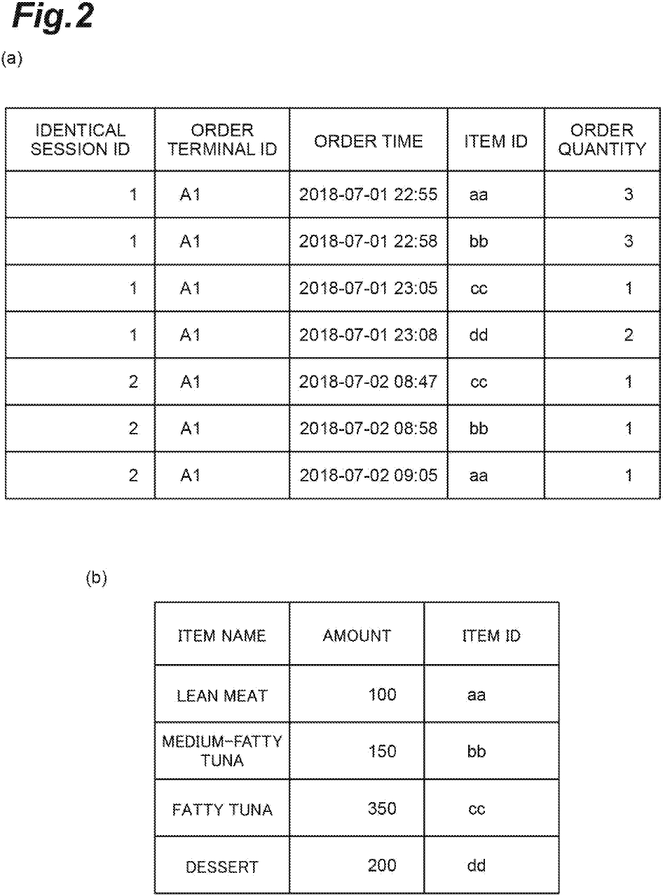

For example, an order panel is provided in a store where items are provided as described above, and the user inputs products (items) to order and the quantity to the order panel. The acquisition unit 11 acquires information input to the order panel as order history information. An example of order history information to be acquired is shown in FIG. 2(a). As shown in FIG. 2(a), the order history information is information in which pieces of information such as an identical session ID, an order terminal ID, an order time, an item ID, and an order quantity are associated with each other.

The identical session ID is an ID (information) for specifying a session, that is, an ID given to the identical user’s account. The order terminal ID is an ID (information) for specifying the order panel which is used by the user. An ID is given to each order panel in a store in advance. In one session, the order panel used by the user is a specific order panel (for example, the order panel provided at the user’s seat). The identical session ID is given, for example, when a new order is placed after the previous account is completed for the order terminal ID, that is, when a new session starts. The order time is a time when an order was placed by the user, for example, information of year, month, day, and time. The item ID and the order quantity are an ID (information) for specifying items ordered by the user and the number of items ordered.

The recommendation system 10 stores item ID management information in advance as master data in a data server or the like. An example of the item ID management information is shown in FIG. 2(b). As shown in FIG. 2(b), the item ID management information is information in which pieces of information of an item name, an amount, and an item ID are associated with each other. The item name and the amount are the item name and amount of an item of an associated item ID. The item name and the amount can be ascertained from the item ID by referring to the item ID management information.

The acquisition unit 11 acquires the order history information each time the user places an order on the order panel. That is, the acquisition unit 11 acquires the information each time the user places an order on the order panel and one row of data in FIG. 2(a) is generated. Meanwhile, the order history information does not necessarily have to be the above information, and may be an order history in the middle of a series of orders placed by the user, that is, an order history in the middle of a session.

In addition, the acquisition unit 11 acquires information indicating the municipality to which a store at which items are provided belongs as location information. The location information is acquired, for example, by reading out the location information which is input to and stored in the recommendation system 10 in advance by a manager of the recommendation system 10. Meanwhile, the location information does not necessarily have to be the above information, and may be information relating to a location where an item is provided. For example, the location information may be information indicating the surrounding situation of the store location.

In addition, the acquisition unit 11 acquires information on a time at which an item is provided in units of one hour (for example, information such as 7:00 pm, 8:00 pm, ^{...}) as time information. As described above, the order history information includes information on the order time. Since the time when an order is placed (order time) and the time when an item is provided are generally the same as each other, the acquisition unit 11 acquires information on the time portion out of year, month, day, and time of the order time included in the order history information as time information. The time information acquired in this way generally indicates the current time at which the recommendation is made. Meanwhile, the time information does not necessarily have to be the above information, and may be information relating to a time when an item is provided.

In addition, each piece of information does not necessarily have to be acquired as described above, and only needs to be acquired using any method by which information can be required. For example, the order history information may be acquired from something other than the order panel. The acquisition unit 11 outputs each piece of acquired information to the determination unit 12. The order history information and the time information are output from the acquisition unit 11 to the determination unit 12 each time the order history information is acquired. The location information only needs to be output from the acquisition unit 11 to the determination unit 12 once per session, for example, together with the output of the first order history information. Alternatively, the acquisition unit 11 may store the acquired information in a data server or the like of the recommendation system 10 so that the acquired information can be referred to by the determination unit 12.

The determination unit 12 is a functional unit that predicts a value related to the total amount of a series of orders placed by the user on the basis of the order history information acquired by the acquisition unit 11 and determines an item to be recommended to the user on the basis of the order history information and the predicted value. The determination unit 12 may make a prediction and a determination using a model that inputs the order history information and the value related to the total amount of the series of orders placed by the user at a point in time prior to a point in time when an item to be recommended is determined and outputs information indicating the item to be recommended to the user and a value related to a total amount of a series of orders placed by the user at a point in time when the item to be recommended is determined. In addition, the model may be generated through machine learning. The determination unit 12 may make a prediction and a determination also on the basis of the location information acquired by the acquisition unit 11. The determination unit 12 may make a prediction and a determination also on the basis of the time information acquired by the acquisition unit 11. Specifically, the determination unit 12 determines items to be recommended to the user as follows.

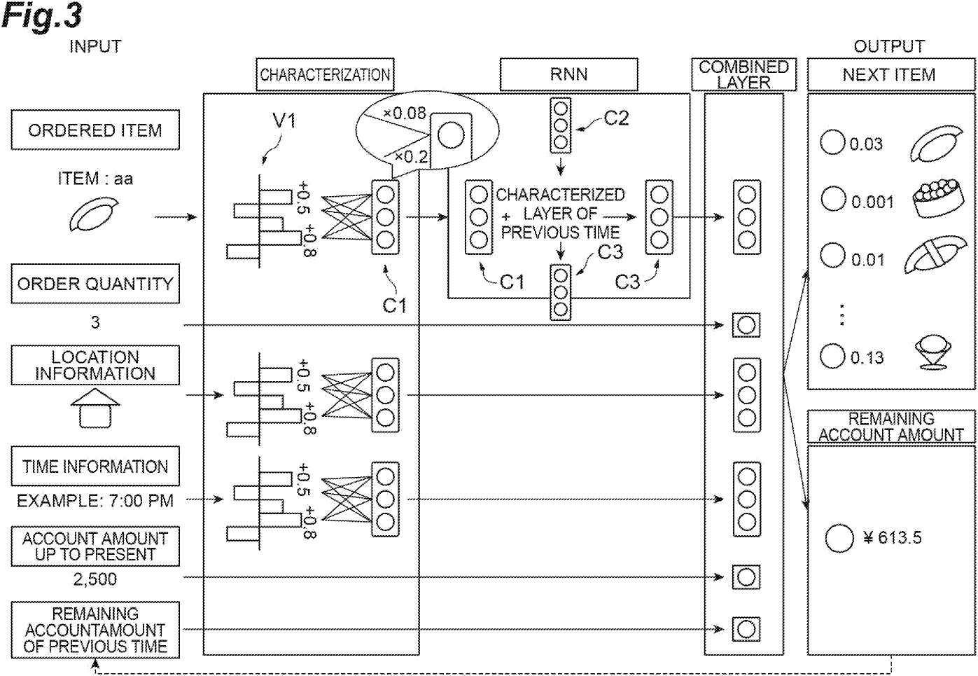

The determination unit 12 recommends the next item to be ordered by the user for the session on the basis of the order history information for each session. The determination unit 12 stores the above model in advance and determines an item to be recommended using the model. FIG. 3 schematically shows a model (algorithm) used to determine an item to be recommended. As shown in FIG. 3, the model is a model for inputting each piece of information such as information on an ordered item, information on the order quantity, location information, time information, information on the account amount up to the present, and information on the remaining account amount of the previous time, and outputting information on an item to be recommended to the user (next item) and information on the remaining account amount (at a point in time when the item to be recommended is determined). The model is configured to include, for example, a neural network generated through machine learning. The neural network may be multi-layered, that is, generated by performing deep learning.

The remaining account amount is a value related to the total amount of a series of orders placed by the user according to the present embodiment. The remaining account amount is an amount spent by the user in the session from that point in time. The remaining account amount is equivalent to an amount left after the amount spent by the user up to that point in time is deducted from the amount spent by the user for the entire session.

The determination unit 12 inputs each piece of information from the acquisition unit 11. Each time new order history information is input, that is, each time the user places a new order, the determination unit 12 predicts (outputs) information on the next item and information on the remaining account amount using the above model.

The information on the ordered item which is input to the model is, for example, an item ID included in the new order history information. The information on the order quantity which is input to the model is, for example, an order quantity included in the new order history information. The location information which is input to the model is, for example, location information which is input from the acquisition unit 11. The time information which is input to the model is, for example, time information which is input from the acquisition unit 11. Meanwhile, the location information and the time information which are input to the model may be ID-coded.

The information on the account amount up to the present which is input to the model is, for example, calculated by the determination unit 12 from the order history information up to that point related to the session. The determination unit 12 refers to the amount of each item in the item ID management information to calculate the account amount up to the present from the item ID and the order quantity in all the order history information related to the session. The information on the remaining account amount of the previous time which is input to the model is, for example, information on the remaining account amount which is output from the model using the order history information immediately preceding the new order history information. In a case where the new order history information is the first order history information related to the session, there is no information on the remaining account amount which is output from the model using the immediately preceding order history information, and thus information on the previous set and stored amount is used as the information on the remaining account amount of the previous time. For example, the amount can be the average account amount or the like of all users in the past.

The information on the next item which is output the model is, for example, a numerical value (a vector with dimensions of the number of items) indicating the degree of recommendation for each item. For example, as shown in FIG. 3, the numerical value is a numerical value in the range of 0 to 1, and it is shown that the degree of recommendation increases as the numerical value becomes larger. This numerical value can also be regarded as the probability that the user will order an item. The information on the remaining account amount (at a point in time when the item to be recommended is determined) which is output from the model is, for example, a numerical value indicating the total amount as shown in FIG. 3.

The determination unit 12 may characterize the information which is input to the model in the computation using the model. The information to be characterized is, for example, the information on the ordered item, the location information, and the time information as shown in FIG. 3. Characterization is performed within the model and can be performed similarly to the related art. The characterization will be described using the characterization of information on an ordered item as an example. First, the determination unit 12 inputs an item ID as the information on the ordered item, and converts it into an N-dimensional vector V1 associated with the item ID in advance (N is set in advance). Next, the determination unit 12 converts the N-dimensional vector V1 into a feature amount C1 which is a preset number of numerical values (that is, a vector with a preset number of dimensions). Each numerical value of the feature amount C1 is equivalent to the numerical value of the neuron in the neural network. The conversion of the vector V1 into the feature amount C1 is performed on the basis of numerical values (weights) set for connection between numerical values in the same way as the normal computation in the neural network. The vector V1 associated with the item ID and a weight for converting the vector V1 into the feature amount C1 are generated through machine learning. Meanwhile, the vector V1 at the start point in time of machine learning is constituted by random numerical values. The location information and the time information are also characterized in the same way as described above and used as feature amounts.

The determination unit 12 inputs the feature amount C1 of the ordered item to a recurrent neural network (RNN) included in the model. In addition, the determination unit 12 inputs a feature amount C2, after processing in the RNN (characterized layer of the previous time) obtained by the computation of the previous order history information in the identical session, to the RNN. The determination unit 12 adds these feature amounts C1 and C2 to generate a feature amount C3. The feature amount C3 generated here is input to the RNN as the above feature amount C2 during the computation of the next order history information in the identical session. In a case where the new order history information is the first order history information related to the session, computation is not performed on the immediately preceding order history information, and thus a preset and stored feature amount (for example, a feature amount with all element values set to 0) is used as the feature amount C2. By using the RNN in this way, it is possible to output the information on the next item and the information on the remaining account amount in consideration of all the items ordered up to that point inclusive of the order.

The determination unit 12 generates information on a combined layer from the information which is input to the model. The information on a combined layer is a simple lateral combination of each piece of information (lateral lining up of each piece of information). For the information on the ordered item, the feature amount C3 generated by the RNN is used as the information on the combined layer. For the location information and the time information, the characterized feature amount C1 is used as the information on the combined layer. For the information on the order quantity, the information on the account amount up to the present, and the information on the remaining account amount of the previous time, the input information is used as it is as the information of the combined layer.

The determination unit 12 calculates information to be output from the information on the combined layer, that is, the information on the next item and the information on the remaining account amount. This calculation is performed on the basis of numerical values (weights) set for connection between numerical values in the same way as the normal computation in the neural network. The weights are generated through machine learning.

The above model can be generated through machine learning, for example, using the order history information in the session that has already been accounted for as learning data (training data). In that case, for the information on the next item corresponding to the output, the numerical value of the item actually ordered next to the new order history information corresponding to the input is set to 1, and the numerical value of the other items is set to 0. In addition, the information on the remaining account amount can be calculated by deducting the account amount up to the new order history information corresponding to the input from the account amount for the entire session. Meanwhile, a model may be generated by the recommendation system 10 or by systems (devices) other than the recommendation system 10.

In addition, the above model used in the recommendation system 10 is assumed to be used as a program module which is a portion of artificial intelligence software. The model is used in a computer including a CPU and a memory. Specifically, the CPU of the computer operates to input information to the input layer of the neural network in accordance with instructions from the model stored in the memory, perform computation based on trained weighting coefficients and the like in the neural network, and output results from the output layer of the neural network.

The determination unit 12 determines the item to be recommended to the user on the basis of the calculated information on the next item. For example, the determination unit 12 determines items with the top N numerical values of the items indicated by the information on the next item as items to be recommended to the user. N here is a numerical value which is set and stored in advance. The determination unit 12 outputs information on the determined item. For example, the determination unit 12 transmits the information on the determined item to the order panel used by the user and causes the order panel to display the item. In this case, the determination unit 12 may refer to the item ID management information to cause to display the item name and amount. Meanwhile, the item to be recommended to the user is not necessarily determined as described above, and only needs to be determined on the basis of the calculated result. In addition, information may also be output using methods other than the above.

The determination unit 12 does not output the calculated information on the remaining account amount in a format that can be referred to by the user, and uses it to make a recommendation for the next order history information as described above. The above is the function of the recommendation system 10 according to the present embodiment.

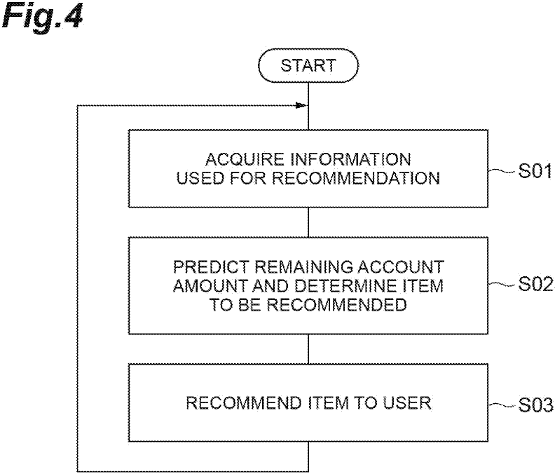

Next, processing which is executed by the recommendation system 10 according to the present embodiment (operation method which is performed by the recommendation system 10) will be described with reference to the flowchart diagram of FIG. 4. This processing is performed for each session described above when the user uses a store. In this processing, the acquisition unit 11 acquires information used to determine an item to be recommended to the user (S01). The acquired information is order history information, location information, and time information. The order history information is information for each order of the user, and the subsequent processing is performed each time the order history information corresponding to one order is acquired.

Next, the determination unit 12 uses a model stored in advance to calculate (predict) the information on the next item and the information on the remaining account amount from the information acquired by the acquisition unit 11 (S02). In addition, the determination unit 12 determines an item to be recommended to the user on the basis of the information on the next item. Next, the determination unit 12 recommends the determined item (S03).

Next, when the user places a newly order, the acquisition unit 11 acquires new order history information and time information related to the order (S01). Meanwhile, the location information only needs to be acquired once in a session. Next, the determination unit 12 calculates (predicts) the information on the next item and the information on the remaining account amount from the new order history information, and makes a recommendation based thereon (S02, S03). The processes of S01 to S03 are repeated each time the user places a new order. The above is the processing which is executed by the recommendation system 10 according to the present embodiment.

In the present embodiment, the remaining account amount is predicted, and the item to be recommended to the user is determined on the basis of the predicted amount. The remaining account amount reflects the characteristics of the user pertaining to the next item to be ordered by the user. Therefore, according to the present embodiment, it is possible to recommend appropriate items in consideration of the user’s remaining account amount at a restaurant or the like such as a conveyor belt sushi restaurant. For example, when the remaining account amount is large, it is considered that many orders will still be placed, and thus sushi items can be recommended. When the remaining account amount is small, it is considered that the meal is nearly finished, and thus desserts can be recommended. In this way, it is possible to recommend items at appropriate timings.

Meanwhile, the value related to the total amount of a series of orders placed by the user is not limited to the remaining account amount used in the present embodiment, and may be any value that allows ascertainment of orders for the entire session. For example, the total account amount for the entire session may be used as a value related to the total amount of a series of orders placed by the user.

In addition, as in the present embodiment, recommendation may be made using a model generated through machine learning to predict both the information on the next item and the information on the remaining account amount. That is, recommendation may be made using multitask learning which is a deep learning technique of solving a plurality of problems by sharing knowledge. It is possible to learn useful features common to problems by sharing a plurality of intermediate layers of prediction as described above. In addition, it is possible to improve the accuracy of prediction by complementing tasks. As a result, according to the present embodiment, it is possible to recommend more appropriate items. However, the information on the next item and the information on the remaining account amount may be calculated by separate models. Alternatively, the calculation may be performed without using the model generated through machine learning.

In addition, recommendation may also be made using the location information and the time information as in the present embodiment. According to this configuration, it is possible to recommend appropriate items according to the location and time at which an item is provided. However, the above information does not necessarily have to be used for the recommendation. In addition, recommendation may be made using information other than the above.

Meanwhile, although recommendation of items at a conveyor belt sushi restaurant has been described as an example in the above-described embodiment, other recommendations may be used. Targets to be recommended by the recommendation system 10 are not limited to items of a restaurant such as a conveyor belt sushi restaurant or a pub, and may be items which are sequentially ordered by the user. For example, the recommendation system may be used to recommend the next song to be sung by the user in a karaoke parlor. In this case, an item to be recommended is (provision of) a musical piece. In addition, in that case, the value related to the total amount of a series of orders placed by the user may be the remaining number of songs or the total number of songs related to the session.

Meanwhile, the block diagram used in the description of the above embodiment represents blocks in units of functions. These functional blocks (constituent elements) are realized by any combination of at least one of hardware and software. In addition, a method of realizing each functional block is not particularly limited. That is, each functional block may be realized using one device which is physically or logically coupled, or may be realized using two or more devices which are physically or logically separated from each other by connecting the plurality of devices directly or indirectly (for example, using a wired or wireless manner or the like). The functional block may be realized by combining software with the one device or the plurality of devices.

Examples of the functions include determining, deciding, judging, calculating, computing, processing, deriving, investigating, searching, ascertaining, receiving, transmitting, outputting, accessing, resolving, selecting, choosing, establishing, comparing, assuming, expecting, considering, broadcasting, notifying, communicating, forwarding, configuring, reconfiguring, allocating (or mapping), assigning, and the like, but there is no limitation thereto. For example, a functional block (constituent element) for allowing a transmitting function is referred to as a transmitting unit or a transmitter. In either case, as described above, realization methods are not particularly limited.

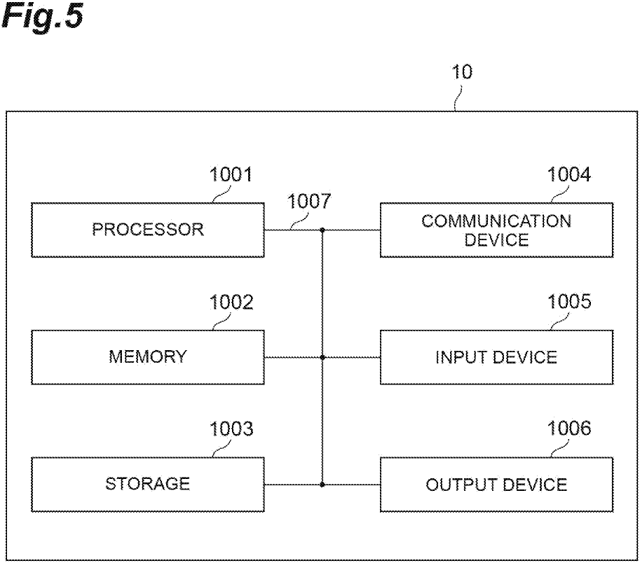

For example, the recommendation system 10 in an embodiment of the present disclosure may function as a computer that performs information processing of the present disclosure. FIG. 5 is a diagram illustrating an example of a hardware configuration of the recommendation system 10 according to an embodiment of the present disclosure. The above-described recommendation system 10 may be physically configured as a computer device including a processor 1001, a memory 1002, a storage 1003, a communication device 1004, an input device 1005, an output device 1006, a bus 1007, and the like.

Meanwhile, in the following description, the word “device” may be replaced with “circuit,” “unit,” or the like. The hardware configuration of the recommendation system 10 may be configured to include one or a plurality of devices shown in the drawings, or may be configured without including some of the devices.

The processor 1001 performs an arithmetic operation by reading predetermined software (a program) onto hardware such as the processor 1001 or the memory 1002, and thus each function of the recommendation system 10 is realized by controlling communication in the communication device 1004 or controlling at least one of reading-out and writing of data in the memory 1002 and the storage 1003.

The processor 1001 controls the whole computer, for example, by operating an operating system. The processor 1001 may be constituted by a central processing unit (CPU) including an interface with a peripheral device, a control device, an arithmetic operation device, a register, and the like. For example, each function in the above-described recommendation system 10 may be realized by the processor 1001.

In addition, the processor 1001 reads out a program (a program code), a software module, data, or the like from at least one of the storage 1003 and the communication device 1004 into the memory 1002, and executes various types of processes in accordance therewith. An example of the program which is used includes a program causing a computer to execute at least some of the operations described in the foregoing embodiment. For example, each function in the recommendation system 10 may be realized by a control program which is stored in the memory 1002 and operates in the processor 1001. Although the execution of various types of processes by one processor 1001 has been described above, these processes may be simultaneously or sequentially executed by two or more processors 1001. One or more chips may be mounted in the processor 1001. Meanwhile, the program may be transmitted from a network through an electrical communication line.

The memory 1002 is a computer readable recording medium, and may be constituted by at least one of, for example, a read only memory (ROM), an erasable programmable ROM (EPROM), an electrically erasable programmable ROM (EEPROM), a random access memory (RAM), and the like. The memory 1002 may be referred to as a register, a cache, a main memory (main storage device), or the like. The memory 1002 can store a program (a program code), a software module, or the like that can be executed in order to carry out information processing according to an embodiment of the present disclosure.

The storage 1003 is a computer readable recording medium, and may be constituted by at least one of, for example, an optical disc such as a compact disc ROM (CD-ROM), a hard disk drive, a flexible disk, a magneto-optic disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium included in the recommendation system 10 may be, for example, a database including at least one of the memory 1002 and the storage 1003, a server, or another suitable medium.

The communication device 1004 is hardware (a transmitting and receiving device) for performing communication between computers through at least one of a wired network and a wireless network, and is also referred to as, for example, a network device, a network controller, a network card, a communication module, or the like.

The input device 1005 is an input device (such as, for example, a keyboard, a mouse, a microphone, a switch, a button, or a sensor) that receives an input from the outside. The output device 1006 is an output device (such as, for example, a display, a speaker, or an LED lamp) that executes an output to the outside. Meanwhile, the input device 1005 and the output device 1006 may be an integrated component (for example, a touch panel).

In addition, respective devices such as the processor 1001 and the memory 1002 are connected to each other through the bus 1007 for communicating information. The bus 1007 may be configured using a single bus, or may be configured using different buses between devices.

In addition, the recommendation system 10 may be configured to include hardware such as a microprocessor, a digital signal processor (DSP), an application specific integrated circuit (ASIC), a programmable logic device (PLD), or a field programmable gate array (FPGA), or some or all of the respective functional blocks may be realized by the hardware. For example, the processor 1001 may be mounted using at least one of these types of hardware.

The order of the processing sequences, the sequences, the flowcharts, and the like of the aspects/embodiments described above in the present disclosure may be changed as long as they are compatible with each other. For example, in the methods described in the present disclosure, various steps as elements are presented using an exemplary order but the methods are not limited to the presented specific order.

The input or output information or the like may be stored in a specific place (for example, a memory) or may be managed using a management table. The input or output information or the like may be overwritten, updated, or added. The output information or the like may be deleted. The input information or the like may be transmitted to another device.

Determination may be performed using a value (0 or 1) which is expressed by one bit, may be performed using a Boolean value (true or false), or may be performed by comparison of numerical values (for example, comparison thereof with a predetermined value).

The aspects/embodiments described in the present disclosure may be used alone, may be used in combination, or may be switched during implementation thereof. In addition, notification of predetermined information (for example, notification of “X”) is not limited to explicit transmission, and may be performed by implicit transmission (for example, the notification of the predetermined information is not performed).

Hereinbefore, the present disclosure has been described in detail, but it is apparent to those skilled in the art that the present disclosure should not be limited to the embodiments described in the present disclosure. The present disclosure can be implemented as modified and changed aspects without departing from the spirit and scope of the present disclosure, which are determined by the description of the scope of claims. Therefore, the description of the present disclosure is intended for illustrative explanation only, and does not impose any limited interpretation on the present disclosure.

Regardless of whether it is called software, firmware, middleware, microcode, hardware description language, or another name, software can be widely construed to refer to commands, a command set, codes, code segments, program codes, a program, a sub-program, a software module, an application, a software application, a software package, a routine, a sub-routine, an object, an executable file, an execution thread, an order, a function, or the like.

In addition, software, a command, information, and the like may be transmitted and received through a transmission medium. For example, when software is transmitted from a website, a server, or another remote source using at least one of wired technology (such as a coaxial cable, an optical fiber cable, a twisted-pair wire, or a digital subscriber line (DSL)) and wireless technology (such as infrared rays or microwaves), at least one of the wired technology and the wireless technology are included in the definition of a transmission medium.

The terms “system” and “network” which are used in the present disclosure are used interchangeably.

In addition, information, parameters, and the like described in the present disclosure may be expressed using absolute values, may be expressed using values relative to a predetermined value, or may be expressed using other corresponding information.

The term “determining” which is used in the present disclosure may include various types of operations. The term “determining” may include regarding operations such as, for example, judging, calculating, computing, processing, deriving, investigating, looking up/search/inquiry (for example, looking up in a table, a database or a separate data structure), or ascertaining as an operation such as “determining.” In addition, the term “determining” may include regarding operations such as receiving (for example, receiving information), transmitting (for example, transmitting information), input, output, or accessing (for example, accessing data in a memory) as an operation such as “determining.” In addition, the term “determining” may include regarding operations such as resolving, selecting, choosing, establishing, or comparing as an operation such as “determining.” That is, the term “determining” may include regarding some kind of operation as an operation such as “determining.” In addition, the term “determining” may be replaced with the term “assuming,” “expecting,” “considering,” or the like.

The terms “connected” and “coupled” and every modification thereof refer to direct or indirect connection or coupling between two or more elements and can include that one or more intermediate element is present between two elements “connected” or “coupled” to each other. The coupling or connecting of elements may be physical, may be logical, or may be a combination thereof. For example, “connection” may be read as “access.” In the case of use in the present disclosure, two elements can be considered to be “connected” or “coupled” to each other using at least one of one or more electrical wires, cables, and printed electric connections or using electromagnetic energy or the like having wavelengths in a radio frequency range, a microwave area, and a light (both visible light and invisible light) area as non-restrictive and non-comprehensive examples.

An expression “on the basis of” which is used in the present disclosure does not refer to only “on the basis of only,” unless otherwise described. In other words, the expression “on the basis of” refers to both “on the basis of only” and “on the basis of at least.”

Any reference to elements having names such as “first” and “second” which are used in the present disclosure does not generally limit amounts or an order of the elements. The terms can be conveniently used to distinguish two or more elements in the present disclosure. Accordingly, reference to first and second elements does not mean that only two elements are employed or that the first element has to precede the second element in any form.

In the present disclosure, when the terms “include,” “including,” and modifications thereof are used, these terms are intended to have a comprehensive meaning similarly to the term “comprising.” Further, the term “or” which is used in the present disclosure is intended not to mean an exclusive logical sum.

In the present disclosure, when articles are added by translation like, for example, “a,” “an” and “the” in English, the present disclosure may include that nouns that follow these articles are plural forms.

In the present disclosure, an expression “A and B are different” may mean that “A and B are different from each other.” Meanwhile, the expression may mean that “A and B are different from C.” The terms “separated,” “coupled,” and the like may also be construed similarly to “different.”

Reference Signs List

| | |
|---|---|
| 10 | Recommendation system |
| 11 | Acquisition unit |
| 12 | Determination unit |
| 1001 | Processor |
| 1002 | Memory |
| 1003 | Storage |
| 1004 | Communication device |
| 1005 | device |
| 1006 | Output device |
| 1007 | Bus |

1. A recommendation system comprising circuitry configured to:
acquire order history information indicating an order history in the middle of a series of orders placed by a user; and
predict a value related to a total amount of the series of orders placed by the user on the basis of the order history information and determine an item to be recommended to the user on the basis of the order history information and the predicted value.

2. The recommendation system according to claim 1, wherein the circuitry predicts a remaining account amount or a total account amount as the value related to the total amount of the series of orders placed by the user.

3. The recommendation system according to claim 1, wherein the circuitry makes a prediction and a determination using a model that inputs the order history information and the value related to the total amount of the series of orders placed by the user at a point in time prior to a point in time when an item to be recommended is determined and outputs information indicating the item to be recommended to the user and a value related to a total amount of a series of orders placed by the user at a point in time when the item to be recommend is determined.

4. The recommendation system according to claim 3, wherein the model is generated through machine learning.

5. The recommendation system according to claim 1, wherein the circuitry acquires location information relating to a location where an item is provided, and
makes a prediction and a determination also on the basis of the location information.

6. The recommendation system according to claim 1, wherein the circuitry
acquires time information relating to a time at which an item is provided, and
makes a prediction and a determination also on the basis of the time information.

7. The recommendation system according to claim 2, wherein the circuitry makes a prediction and a determination using a model that inputs the order history information and the value related to the total amount of the series of orders placed by the user at a point in time prior to a point in time when an item to be recommended is determined and outputs information indicating the item to be recommended to the user and a value related to a total amount of a series of orders placed by the user at a point in time when the item to be recommend is determined.
